(19) United States
(12) Patent Application Publication
(10) Pub. No.: US 2005/0199109 A1
(43) Pub. Date: Sep. 15, 2005

(54) Dual function wrench

(76) Inventor: Chih-Ching Hsien, Taichune (TW)

Correspondence Address: Mr. Phillip LIU, 6980, Whiteoak Dr., Richmond, BC, V7E 4Z9, CA

(21) Appl. No.: 10/797,090

(22) Filed: Mar. 11, 2004

(51) Int. Cl. B25B 13/00

(52) U.S. Cl. 81/186

(57) ABSTRACT

A dual function wrench includes two different function ends at the head of the wrench and the two different function ends are overlapped with each other. Each function end includes a clamping space and the two respective clamping spaces are in communicating with each other.

### FIELD OF THE INVENTION

The present invention relates to a wrench that has two different functional ends overlapped connected with each other so as to perform two different functions.

### BACKGROUND OF THE INVENTION

A conventional hand tool such as wrench includes a driving end which can be an open end or a box end. Each of the open end or box end has its fixed function which is designed for a certain purpose such that the users usually prepare several different types of wrenches for completing different works. Taken the open end of a wrench as an example, the opening between two jaws can be designed very close to the size of object to be clamped so that the object is rotated with the wrench. Nevertheless, the user has to remove the wrench from the object and re-clamp the object again to rotate the object if the space for rotation of the wrench is limited. This spends too much time on removing and re-clamping the wrench. Another speed wrench was developed which allows the user to reciprocate the wrench without removing the wrench from the object. Nevertheless, the opening between the two jaws is a little bit larger than the object to be clamp so that the clamped object could be rounded during operating, although the wrench is convenient for the users. In some situation, the object needs to be firmly tightened by using the conventional wrench, not the speed wrench. The users still need to change another tool.

The present invention intends to provide a wrench that has dual function driving head such that the users need not to change another tool frequently.

### SUMMARY OF THE INVENTION

The present invention relates to a dual function wrench which comprises a driving head and a shank connected to the driving head. The driving head includes a first function end and a second function end, wherein the first function end is overlapped to the second function end. Each of the first function end and the second function end has a clamping space and the two respective clamping spaces are different from each other and in communication with each other.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a first embodiment of the dual function wrench of the present invention;

FIG. 2 shows a nut is clamped by one of the function ends of the dual function wrench of the present invention;

FIG. 3 shows a nut is clamped by the other one of the function ends of the dual function wrench of the present invention;

FIG. 4 is a side cross sectional view to show a bolt head is clamped by one of the function ends of the dual function wrench of the present invention;

FIG. 5 is a side cross sectional view to show a bolt head is clamped by the other one of the function ends of the dual function wrench of the present invention;

FIG. 6 is a perspective view to show a second embodiment of the dual function wrench of the present invention;

FIG. 7 shows a plane view of the dual function wrench of the present invention in FIG. 6;

FIG. 8 is a side cross sectional view to show a bolt head is clamped by one of the function ends of the dual function wrench in FIG. 6;

FIG. 9 is a side cross sectional view to show a bolt head is clamped by the other one of the function ends of the dual function wrench in FIG. 6;

FIG. 10 is a perspective view to show a third embodiment of the dual function wrench of the present invention, and

FIGS. 11 and 12 show the top and the bottom view of the third embodiment of the dual function wrench of the present invention.

### DETAILED DESCRIPTION OF THE PREFERRED EMBODIMENT

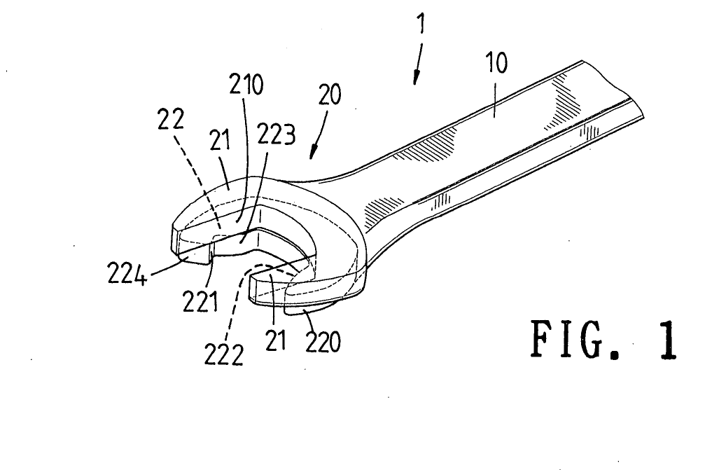

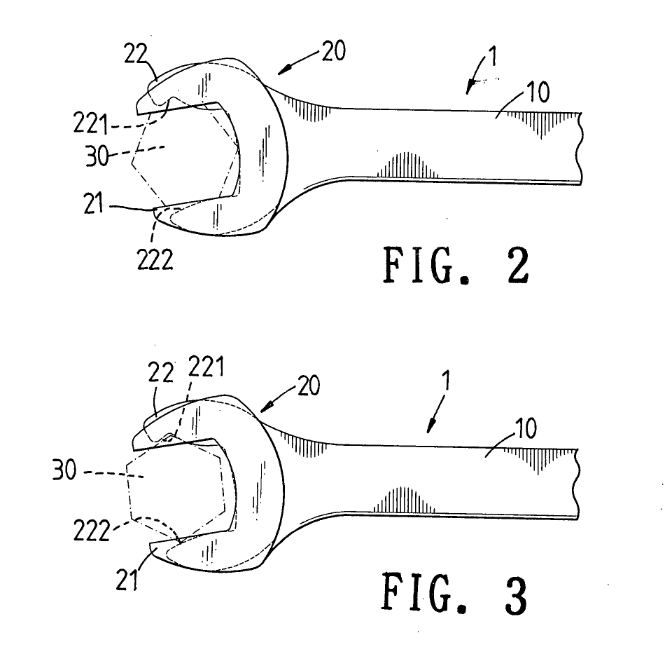

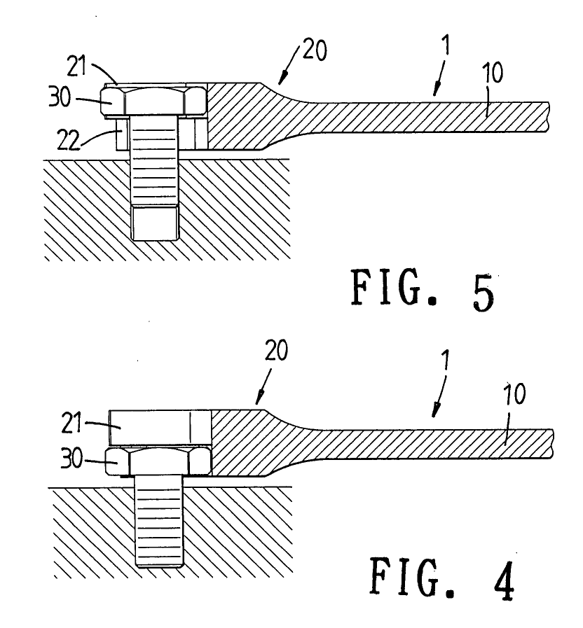

As shown in FIG. 1, the dual function wrench 1 of the present invention comprises a driving head 20 and a shank 10 connected to the driving head 20. The driving head 20 includes a first function end and a second function end. The first function end is overlapped to the second function end, and each of the first function end and the second function end has a clamping space and the two respective clamping spaces are different from each other and in communication with each other. FIGS. 1 to 5 show a first embodiment of the present invention, wherein the first function end includes two fixed jaws 21 and the two fixed jaws have two respective flat clamping surfaces 210 facing with each other. Therefore, two opposite sides of a bolt head 30 can be clamped by the two respective flat clamping surfaces 210 as shown in FIG. 3.

The second function end includes a first jaw 220 and a second jaw 22. The first jaw 220 has a first convex surface 222 facing the second jaw 22, and the second jaw 22 has a second convex surface 223 facing the first convex surface 222. A protrusion 224 extends from a distal end of an inside of the second jaw 22 and toward the first jaw 220, the protrusion 224 has a clamping area 221 which is connected to an end of the second convex surface 223. The second function end is a speed wrench which allows the user to reciprocally operate the wrench without removing the second function end from the bolt head 30. When in use, if the space for the operation of the handle 10 is narrow, the user may clamp the bolt head 30 by the second function end so as to rotate the bolt head 30 efficiently and quickly. The first function end can firmly clamp the bolt head 30 to prevent form damaging the bolt head 30.

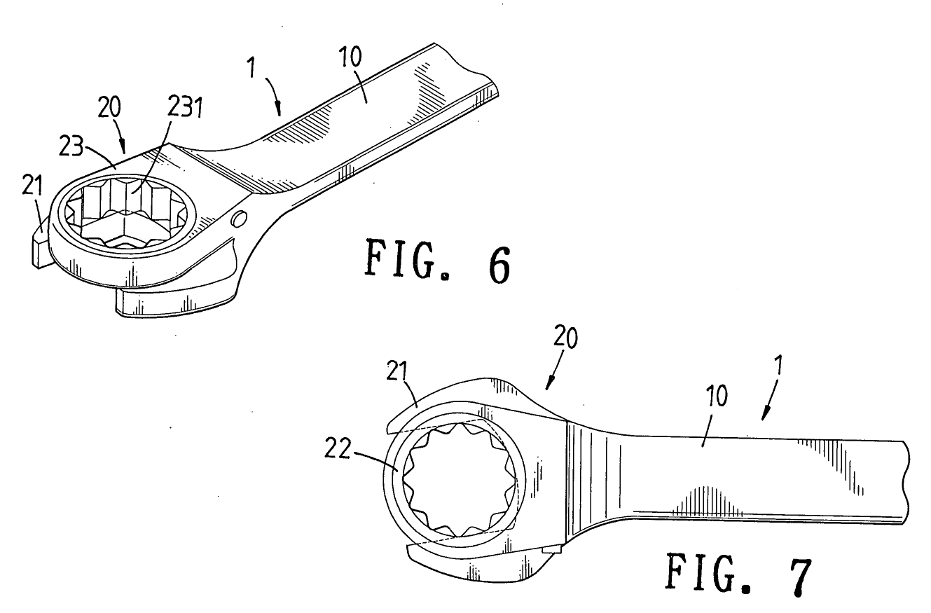

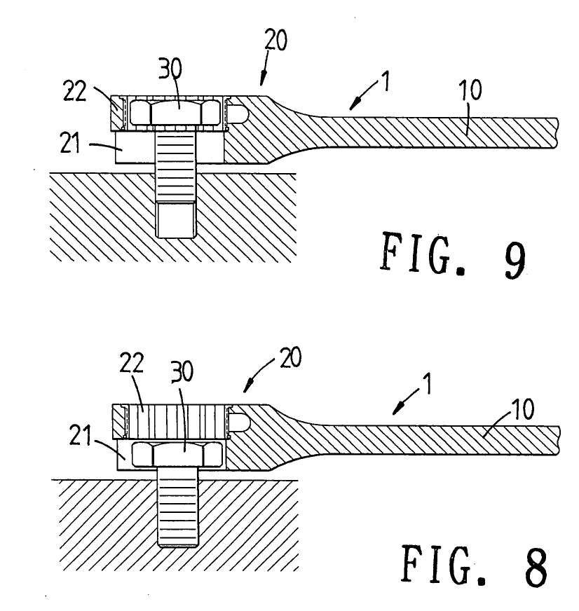

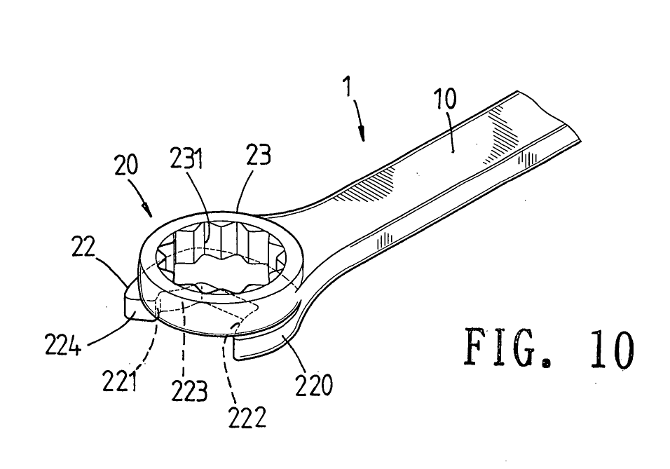

FIGS. 6 to 9 show a second embodiment of the present invention, wherein the first function end is the same as disclosed in FIG. 1 and includes two fixed jaws 21. The second function end is a ratchet box end 23 which has a toothed inner periphery 231 and a space enclosed by the toothed inner periphery 231 communicates with the clamping space between the two fixed jaws 21 of the first function end.

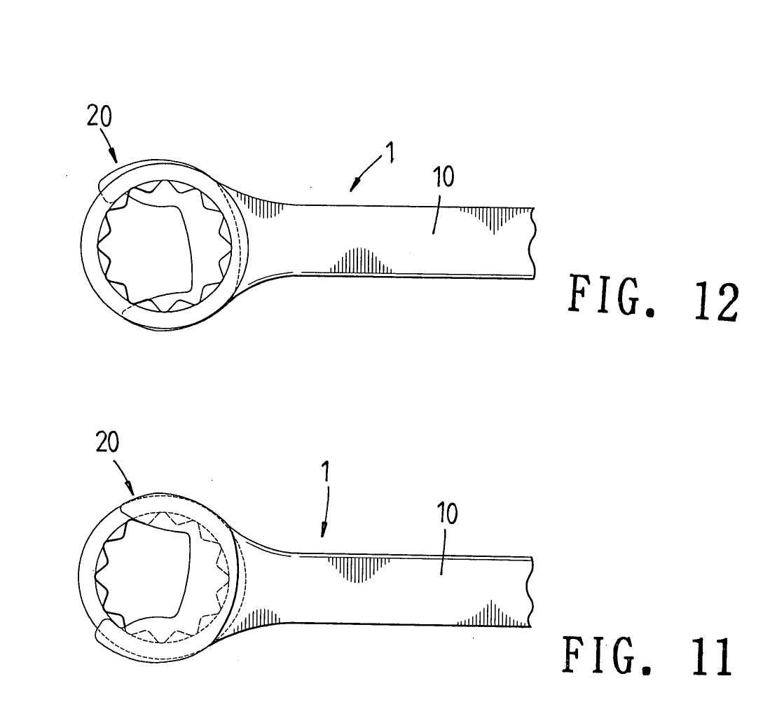

FIGS. 10 to 12 show a third embodiment of the present invention wherein the first function end is a ratchet box end 23 as disclosed in FIG. 6 and includes a toothed inner periphery 231. The second function end is a speed wrench end including a first jaw 220 and a second jaw 22. The first jaw 220 has a first convex surface 222 facing the second jaw 22. The second jaw 22 has a second convex surface 223 facing the first convex surface 222. A protrusion 224 extends from a distal end of an inside of the second jaw 22 and toward the first jaw 220. The protrusion 224 has a clamping area 221 which is connected to an end of the second convex surface 223. A space enclosed by the toothed inner periphery 231 communicates with the clamping space between the first jaw 220 and the second jaw 22.

While we have shown and described the embodiment in accordance with the present invention, it should be clear to those skilled in the art that further embodiments may be made without departing from the scope of the present invention.

1. A dual function wrench comprising:
a driving head and a shank connected to the driving head, the driving head including a first function end and a second function end, the first function end being overlapped to the second function end, each of the first function end and the second function end having a clamping space and the two respective clamping spaces being different from each other and in communication with each other, the first function end including two fixed jaws and the two fixed jaws having two respective flat clamping surfaces facing with each other, the second function end including a first jaw and a second jaw, the first jaw having a first convex surface facing the second jaw, the second jaw having a second convex surface facing the first convex surface, a protrusion extending from a distal end of an inside of the second jaw and toward the first jaw, the protrusion having a clamping area which is connected to an end of the second convex surface.

2. (canceled)

3. (canceled)

4. (canceled)

5. (canceled)

6. A dual function wrench comprising:
a driving head and a shank connected to the driving head, the driving head including a first function end and a second function end, the first function end being overlapped to the second function end, each of the first function end and the second function end having a clamping space and the two respective clamping spaces being different from each other and in communication with each other, the first function end including two fixed jaws and the two fixed jaws having two respective flat clamping surfaces facing with each other, the second function end being a ratchet box end which has a toothed inner periphery, a space enclosed by the toothed inner periphery communicating with the clamping space between the two fixed jaws.

7. A dual function wrench comprising:
a driving head and a shank connected to the driving head, the driving head including a first function end and a second function end, the first function end being overlapped to the second function end, each of the first function end and the second function end having a clamping space and the two respective clamping spaces being different from each other and in communication with each other, the first function end being a ratchet box end which has a toothed inner periphery, the second function end including a first jaw and a second jaw, the first jaw having a first convex surface facing the second facing the second jaw having a second convex surface facing the first convex surface, a protrusion extending from a distal end of an inside of the second jaw and toward the first jaw, the protrusion having a clamping area which is connected to an end of the second convex surface, a space enclosed by the toothed inner periphery communicating with the clamping space between the first jaw and the second jaw.
